(19) United States
(12) Patent Application Publication
(10) Pub. No.: US 2009/0207893 A1
(43) Pub. Date: Aug. 20, 2009

(54) HF CONVERTER FOR MOBILE DEVICES

(75) Inventors: THOMAS LEUTGEB, Lieboch (AT); Walter Kargl, Graz (AT); Dietmar Scheiblhofer, Kaindorf (AT); Helmut Horvat, Graz (AT); Peter Raggam, St. Stefan I. R. (AT); Wolfgang Meindl, Graz (AT)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 12/033,290

(22) Filed: Feb. 19, 2008

(51) Int. Cl. H04L 29/06; H04B 1/38

(52) U.S. Cl. 375/219; 455/73

(57) ABSTRACT

A high frequency (HF) converter for a mobile device, having an input device configured to receive a first signal including data in accordance with a standard, non-HF communication protocol or in accordance with an HF communication protocol; a converter device coupled to the input device, the converter device configured to convert the first signal to a second signal including the data in accordance with the other of the HF communication protocol and the standard, non-HF communication protocol; and an output device configured to transmit the second signal.

### BACKGROUND OF THE INVENTION

This invention relates generally to converters, and more particularly to a method and apparatus for converting near field protocol communication signals to communication signals having other protocols.

Mobile devices such as cellular telephones, portable media players, smartphones, personal digital assistants (PDAs), personal communicators, handheld game consoles, mobile PCs, handheld televisions, laptop computers, and the like are expected to perform their intended functions as well as additional non-traditional functions including high frequency (HF) communication functions. HF communication functions include contactless chipcard functions such as ticketing, payment, and the like. These additional functions are implemented using near field communication (NFC) technology.

NFC technology is a short-range wireless connectivity technology that enables simple and safe two-way interactions among electronic devices, allowing consumers to perform contactless transactions, access digital content and connect electronic devices. In other words, NFC technology enables contactless, bi-directional communication between devices. These devices can be NFC-equipped mobile phones, computers, consumer electronics, cards, tags, signs, posters, washing machines, and the like. An NFC technology enabled device can operate in reader/writer, peer-to-peer, or card emulation mode.

NFC technology is a contactless technology in the 13.56 MHz frequency band. ISO 14443 standard is a key building block for much of the near field operations. NFC technology is generally compatible with at least the ISO 14443 Type A and B standards. The components of an NFC session include initiators and targets. The initiator is the device that begins and manages the communication and exchange of data. The target responds to requests from the initiator. A feature of NFC technology is that devices can act as either an initiator or a target.

NFC technology requires a dedicated HF chip set and antenna to be designed into the mobile device. It should be noted that the dedicated HF chip set and antenna are not easily added to mobile devices due to the material of the mobile device, e.g., aluminum or titanium, because different materials used in the mobile device affect the reception and transmission of HF signals. Additionally, there is limited availability or selection of a specific chip set because HF chip sets are not standard. In other words, each HF chip set has discrete pinning and logical access.

### SUMMARY OF THE INVENTION

A high frequency (HF) converter for a mobile device, having an input device configured to receive a first signal including data in accordance with a standard, non-HF communication protocol or in accordance with an HF communication protocol; a converter device coupled to the input device, the converter device configured to convert the first signal to a second signal including the data in accordance with the other of the HF communication protocol and the standard, non-HF communication protocol; and an output device configured to transmit the second signal.

### BRIEF DESCRIPTION OF THE DRAWINGS

FIG. 1 is a block diagram of a communication system in accordance with an embodiment of the invention;

FIG. 2 depicts a communication system in accordance with an embodiment of the invention;

FIG. 3A is a converter implemented in a headset in accordance with an embodiment of the invention;

FIG. 3B is a block diagram of a circuit in the headset of FIG. 3A;

FIG. 4 is a block diagram of a converter circuit in accordance with an embodiment of the invention; and

FIG. 5 is a flowchart illustrating a method of transforming a signal in accordance with an embodiment of the present invention.

### DESCRIPTION OF THE PREFERRED EMBODIMENTS

Disclosed is a high frequency (HF) converter for a mobile device that is not capable of HF communications, only standard, non-HF communication protocols. In particular, the HF converter for a mobile device includes a converter that can convert standard, non-HF protocol signals such as UHF, Bluetooth, IR, wired connection, wireless LAN, WiFi, WiMax, an IEEE 802 protocol signal, or the like, to HF protocol signals and preferably, to an HF signal in accordance with the ISO 14443 standard. The disclosed HF converter is configured to communicate via a standard, non-HF protocol so that an associated mobile device can communicate with HF devices. The HF converter is preferably external to the mobile device. In this manner, the housing material of the mobile device will not affect the HF communications. Additionally, because the HF converter is a discrete device, in one embodiment it is designed to accept multiple HF chip sets, either using different printed circuit (PC) boards or adaptive PC boards.

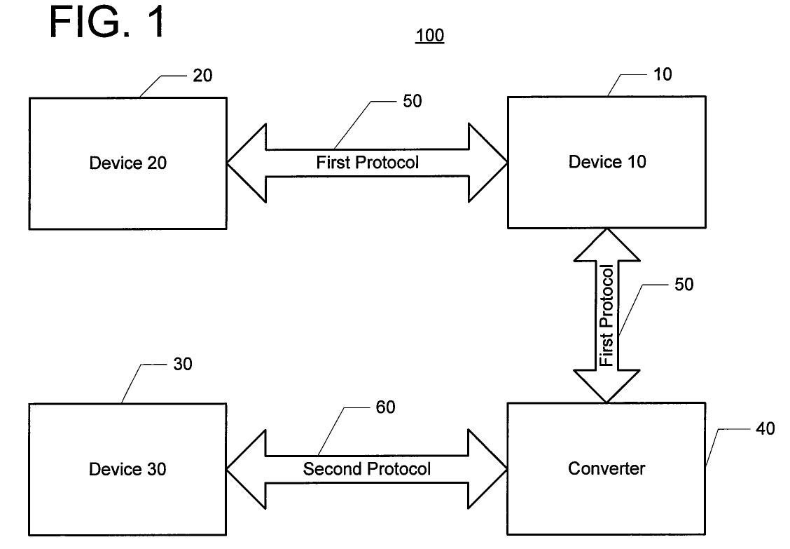

FIG. 1 is a block diagram of a communication system 100 in accordance with an embodiment of the invention. As shown, a device 10 is adapted to communicate via a first communication protocol 50. Device 10 is preferably an HF compatible device, and in particular an ISO 14443 compatible device. The first communication protocol 50 is preferably an HF connection, for example, a connection in accordance with the ISO 14443 standard. However, other communication protocols can be used. Device 20 is an HF compatible mobile device capable of direct communication with device 10 via first communication protocol 50.

A device 30 communicates via a second communication protocol 60. The second communication protocol 60 can be a standard, non-HF communication protocol like a UHF connection such as Bluetooth, or may alternatively be an IR communication protocol, a wired connection, a wireless LAN connection, a WiFi connection, Vmax, or the like. Since device 30 and device 10 communicate via different communication protocols, they are unable to communicate directly, but instead must communication via converter 40.

Device 30 communicates with converter 40 via the second communication protocol 60, and communicates with device 10 via the first communication protocol 50. Converter 40 is adapted to receive signals from device 10 via the first communication protocol 50, convert the received signals to the second communication protocol 60, and retransmit the converted signals to device 30 via the first communication protocol 50. Conversely, converter 40 can receive signals from device 30 via the second communication protocol 60, convert the received signals to the first communication protocol 50, and retransmit the converted signals to device 10.

In order to support the converter 40, software running on device 30 is updated so that the device 30 is able to transmit and receive signals via the second communication protocol 60 that can be converted to the first communication protocol 50. For example, software on device 30 can be updated so that device 30 can receive and transmit a signal via a Bluetooth connection to converter 40, which can convert the Bluetooth signal to an NFC signal such that ISO 14443 compatible device 10 can use the converted signal for point of sale purchasing, and the like. This software can be pushed to device 30 from a central location such as a cellular telephone software update, downloaded and installed, installed with an operating system update, or the like. Alternatively, the converter 40 may be adapted to provide software updates.

It should be appreciated that although the communication system 100 of FIG. 1 illustrates two communication protocols 50 and 60, any number of communication protocols in any combination may be used. It should also be appreciated that a single converter can translate multiple communication protocols. Further, it should be appreciated that a single converter can select from among available communication protocols to provide data in accordance with a required communication protocol.

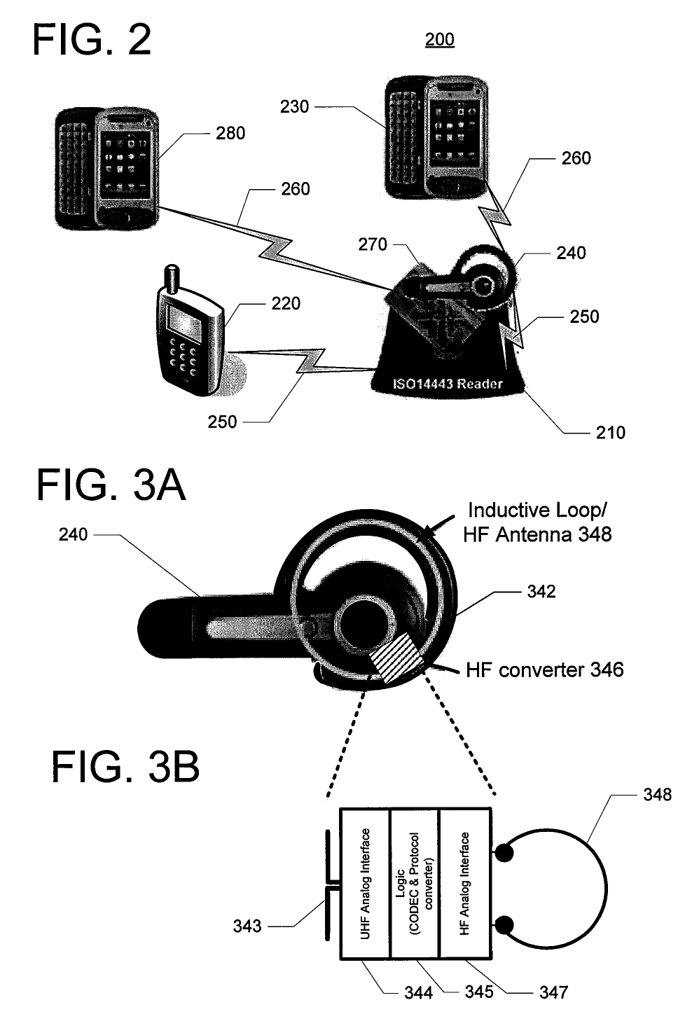

FIG. 2 depicts a system 200 in accordance with an embodiment of the invention. The system includes an ISO 1443 compatible reader 210, a first device 220, a second device 230, and a headset/converter 240.

The ISO 14443 compatible reader 210 is adapted to communicate via a first communication protocol 250. In a preferred embodiment, the first communication protocol 250 is an HF connection such as an ISO 14443 type A or B connection. The first device 220 is adapted to communicate with the ISO 14443 compatible reader 210 via the first communication protocol 250 directly. Second device 230 is a mobile device that does not have the capability of communicating via first communication protocol 250. Rather, second device 230 communicates using a second communication protocol 260, which may be a UHF connection such as Bluetooth, WiFi, IR, an IEEE 802 protocol signal, or the like. Second device 230 is able to communicate with a device such as headset 240, which acts as a converter between second device 230 and ISO 14443 compatible reader 210.

Headset 240 is depicted as a Bluetooth headset. The Bluetooth headset (converter) 240 is adapted to receive communication signals from the ISO 14443 compatible reader 210 via the first communication protocol 250, convert the received signals to the second communication protocol 260, which is preferably a Bluetooth signal, and transmit the converted signals to linked second device 230. Conversely, the headset 240 is also able to receive signals from second device 230 via the second communication protocol 260, and convert the received signals so that they can be transmitted to and read by ISO 14443 compatible reader 210 via the first communication protocol 250. It should be noted that while headset 240 is shown as a Bluetooth headset, any device such as a contactless card 270, fob, or the like, can be adapted to be a converter. As shown, device 280, like device 230, communicates with by ISO 14443 compatible reader 210 via a contactless card 270, which acts as a converter.

For the second device 230 to communicate with an HF compatible device such as ISO 14443 compatible reader 210, communication software may be required. Such software would provide second device 230 with the capability of engaging in HF communication by providing the expected signal via the Bluetooth or second communication protocol 260 to headset 240. Headset 240, which includes a converter, would then convert those signals to first communication protocol 250, which is preferably an HF communication protocol for transmission to the ISO 14443 compatible reader 210. It should be noted that the software would provide second device 230 with an appropriate instruction set for HF communication, although those instructions will be transmitted initially via a non-HF communication protocol. In this manner, devices do not require hardware to engage in HF communications.

FIG. 3A depicts a Bluetooth headset 240. Headset 240 includes an inductive loop HF antenna 348 and an HF converter 346. In a preferred embodiment, the HF loop antenna or inductive loop HF antenna 348 is arranged in an earpiece 342 of the Bluetooth headset.

FIG. 3B depicts a detailed block diagram of the HF converter 346 (shown in FIG. 3A) including the related I/O antennas. As shown, the HF converter 346 is coupled to an inductive loop HF antenna 348 and a UHF antenna 343. It should be noted that antennas 343 and 348 can be adapted for other frequency ranges or other communication protocols such as IR, wireline, wireless LAN, WiFi, Bluetooth, Vmax, or the like.

According to an embodiment of the invention, an HF analog interface 347 is coupled to inductive loop HF antenna 348. The HF analog interface 347 provides signals to, and receives signals from, a logic portion 345 of the HF converter 346. The logic portion 345 of HF converter 346 includes a CODEC and protocol converter. The logic portion of the HF converter 346 performs the conversion between the HF and UHF protocols. It should be noted that HF converter 346 can be implemented using discrete circuitry or via software on a microprocessor. The logic portion 345 is coupled to a UHF analog interface 344. UHF analog interface 344 provides signals to and receives signals from the logic portion 345. Additionally, UHF analog interface 344 is coupled to UHF antenna 343. UHF analog interface 344 receives signals from and provides signals to the UHF antenna 343.

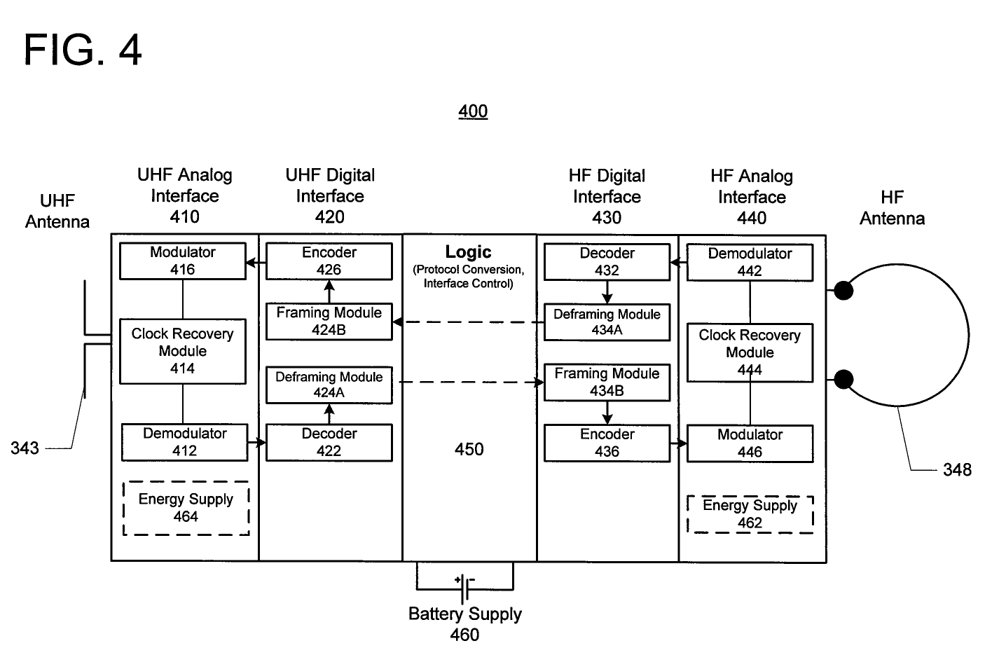

FIG. 4 depicts detailed block diagram 400 of a converter. As shown, the HF converter has an HF interface portion and a UHF interface portion. Specifically, the converter includes a UHF analog interface 410, a UHF digital interface 420 and HF digital interface 430, and an HF analog interface 440. A logic portion 450 of the HF converter performs a protocol conversion and interface control. It should be noted that the HF converter is powered by a battery supply 460. However, in other embodiments, energy supplies 462 and 464 are used. The battery supply 460 as well as energy supplies 462 and 464 can be batteries, solar cells, capacitors, inductive sources, or the like.

UHF analog interface 410 includes a demodulator 412, a clock recovery module 414, and a modulator 416. In one embodiment, as discussed above, the UHF analog interface includes an energy supply 464. The UHF analog interface is coupled to UHF antenna 343. The clock recovery module 414 provides a clock signal for modulator 416 and demodulator 412.

UHF digital interface 420 includes, among other elements, a decoder 422, a framing module 424B, a deframing module 424A, and an encoder 426. The HF digital interface 430 includes a decoder 432, framing module 434B, a deframing module 434A, and an encoder 436. Finally, HF analog interface 440 includes a demodulator 442, clock recovery module 444, and modulator 446. In one embodiment, the HF analog interface 440 includes an energy supply 462.

In operation, the UHF antenna 343 receives a UHF signal. Demodulator 412, in accordance with a clock from clock recovery module 414, demodulates this UHF signal. The demodulated signal is presented to decoder 422, which decodes the signal. The decoded signal is then deframed by deframing module 424. The processed signal undergoes protocol conversion under the control of logic portion 450. It should be noted that logic portion 450 also performs interface control of the HF converter. After the conversion by logic portion 450, the signal is processed by the HF digital interface 430. Here, the signal is framed by framing module 434B and encoded by encoder 436. The encoded signal is then modulated by modulator 446 in accordance with a clock signal from clock recovery module 444, and transmitted via the inductive loop HF antenna 348.

Signals received by the inductive loop HF antenna 348 are presented to demodulator 442. These signals are demodulated in accordance with a clock signal from clock recovery module 444. The demodulated signals are then decoded by decoder 432 and deframed by deframing module 434A. These deframed signals are then processed by logic portion 450 where protocol conversion takes place. It should be noted that logic portion 450 can be implemented using discrete components or in software. The protocol converted signal is then presented to framing module 424B where the signal is framed and then encoded by encoder 426. The encoded signal is then modulated by modulated 416 in accordance with a clock signal from clock recovery module 414 for transmission via UHF antenna 343. It should be noted that the HF converter can act in a passive mode i.e., a card emulation mode, or an active mode, i.e., a reader mode.

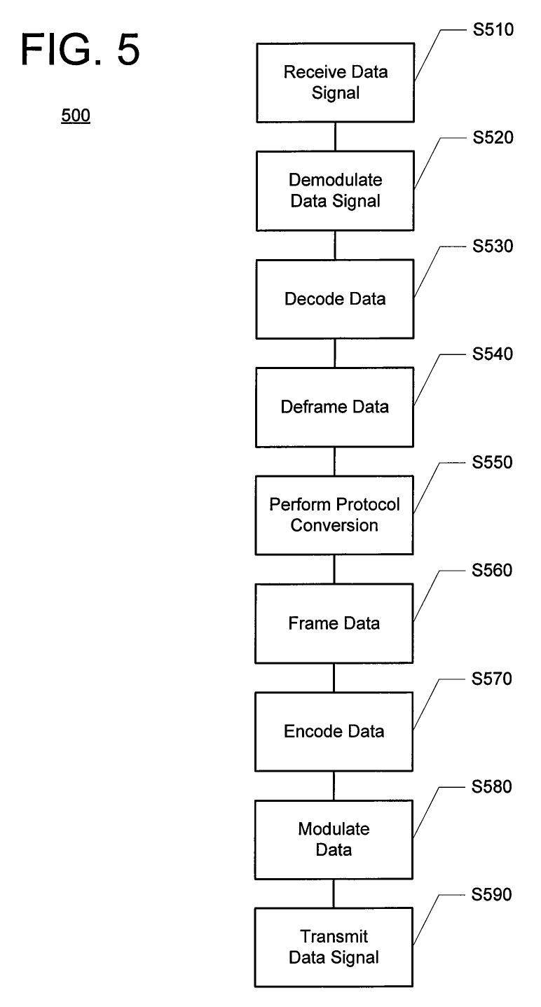

Referring now to FIG. 5, there is seen a flow chart 500 illustrating a method of converting a data signal in accordance with an embodiment of the present invention. The operation begins when a transmitted data signal is received (S510). In a variant of the present embodiment, data is transmitted via an amplitude shift key (ASK) modulated signal. The received signal is then demodulated (S520) and decoded (S530). The demodulated and decoded data is then deframed (S540). Deframing entails removing packets of data from the overhead. Once the data is available, a protocol conversion takes place (S550). Protocol conversion converts the data from a first protocol to a second protocol. This conversion can include compression, decompression, coding, decoding, and the like. In a variant of the present embodiment, the protocol conversion is from data compliant with ISO 14443 type A or B to Bluetooth compliant data, or vice versa. Once the data protocol conversion is complete, the data is reframed in accordance with the new data protocol (S560). The framed data is then encoded (S570) and modulated (S580). In a variant of the present embodiment, Gaussian frequency shift keying (GFSK) modulation is employed. Once modulated, the data signal is transmitted (S590).

While the method above was described with respect to FIG. 5, additional steps including filtering, amplification, and the like are typically performed. Additionally, multiple protocol conversions may be performed. As such, in an embodiment of the invention, a user can select a desired protocol conversion. In another embodiment, the protocol conversion is selected based on the available data sources.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A high frequency (HF) converter for a mobile device, comprising:
an input device configured to receive a first signal including data in accordance with a standard, non-HF communication protocol or in accordance with an HF communication protocol;
a converter device coupled to the input device, the converter device configured to convert the first signal to a second signal including the data in accordance with the other of the HF communication protocol and the standard, non-HF communication protocol, respectively; and
an output device configured to transmit the second signal.

2. The HF converter according to claim 1, further comprising a first interface coupled to the input device, the first interface configured to extract the data from the first signal.

3. The HF converter according to claim 1, further comprising a second interface device coupled to the converter device, the second interface device configured to embed the data in the second signal.

4. The HF converter according to claim 1, wherein the input device is a UHF antenna.

5. The HF converter according to claim 1, wherein the input device is a HF antenna.

6. The HF converter according to claim 5, wherein the first signal is a near field communication signal.

7. The HF converter according to claim 4, wherein the second signal is a Bluetooth communication signal.

8. The HF converter according to claim 1, wherein the HF converter is implemented in a headset.

9. The HF converter according to claim 1, wherein the HF converter is implemented in a chip card.

10. The HF converter according to claim 1, wherein the HF converter is bidirectional.

11. The HF converter according to claim 1, further comprising an inductive power source.

12. The HF converter for a mobile device according to claim 8, wherein the input device is a HF antenna located in an earpiece of the headset.

13. A high frequency (HF) converter for a mobile device comprising:
a UHF analog interface;
a UHF digital interface coupled to the UHF analog interface;
a converter circuit coupled to the UHF digital interface, the converter circuit configured to convert signals between UHF and HF protocol;
an HF digital interface coupled to the converter circuit; and
an HF analog interface coupled to the HF digital interface.

14. The HF converter according to claim 13, wherein the UHF analog interface comprises:
a modulator configured to modulate a converted signal;
a demodulator configured to demodulate a received signal; and
a clock recovery module.

15. The HF converter according to claim 13, wherein the UHF digital interface comprises:
a framing module configured to frame converted data;
an encoder configured to encode the converted data;
a deframing module configured to deframe received data; and
a decoder configured to decode the received data.

16. The HF converter according to claim 13, wherein the HF analog interface comprises:
a modulator configured to modulate a converted signal;
a demodulator configured to demodulate a received signal; and
a clock recovery module.

17. The HF converter according to claim 13, wherein the HF digital interface comprises:
a framing module configured to frame converted data;
an encoder configured to encode the converted data;
an decoder configured to decode received data; and
a deframing module configured to deframe the received data.

18. The HF converter according to claim 13, wherein the converter circuit is configured to convert a data signal from a first communication protocol to a second communication protocol.

19. The HF converter according to claim 18, wherein the first communication protocol is a near field communication protocol.

20. The HF converter according to claim 19, wherein the second communication protocol is a Bluetooth communication protocol.

21. The HF converter according to claim 19, wherein the second communication protocol is a wireless communication protocol.

22. A method of converting a data signal in a mobile device comprising:
receiving a first signal including data in accordance with a standard, non-HF communication protocol or in accordance with an HF communication protocol;
demodulating and decoding the first signal;
deframing the data from the first signal;
converting the data from the first signal to a second signal including the data in accordance with the other of the HF communication protocol and the standard, non-HF communication protocol;
framing the converted data;
encoding and modulating the framed, converted data; and
transmitting the framed, converted data.

23. The method according to claim 22, wherein the first signal is transmitted in accordance with a near field communication signal protocol and the second signal is transmitted in accordance with a Bluetooth communication protocol.

24. A communication system, comprising:
a mobile device configured to communicate using a standard, non-HF communication protocol;
a reader configured to communicate using an HF communication protocol; and
a converter device coupled to the mobile device and to the reader, the converter device configured to convert signals between the HF communication protocol and the non-HF communication protocol to allow the mobile device and the reader to communicate with one another.

25. A high frequency (HF) converter for a mobile device comprising:
a UHF analog interface;
a UHF digital interface coupled to the UHF analog interface;
a converter means, which is coupled to the UHF digital interface, for converting signals between UHF and HF protocols;
an HF digital interface coupled to the converter circuit; and
an HF analog interface coupled to the HF digital interface.
